(19) United States
(12) Patent Application Publication
(10) Pub. No.: US 2011/0205502 A1
(43) Pub. Date: Aug. 25, 2011

(54) PROJECTOR

(75) Inventors: Hideki KATO, Kitasaku-gun (JP); Atsushi KITAMURA, Kitasaku-gun (JP)

(73) Assignee: MINEBEA CO., LTD., Kitasaku-gun (JP)

(21) Appl. No.: 13/029,662

(22) Filed: Feb. 17, 2011

(30) Foreign Application Priority Data
Feb. 23, 2010 (JP) 2010-037401
Feb. 24, 2010 (JP) 2010-038748

(51) Int. Cl. G03B 21/14

(52) U.S. Cl. 353/84

(57) ABSTRACT

There is provided a projector at least comprising: a light source; a color wheel; a condensing lens; a spatial light modulator; and a projection optical system, wherein the light source includes a red illuminant and a blue illuminant, and the color wheel includes a disc made of optically permeable materials, the disc being composed of a green-light generating portion, a blue-light generating portion and a blue-and-green light generating portion, the green-light generating portion and the blue-and-green light generating portion each including a phosphor layer.

### BACKGROUND OF THE INVENTION

1. Field of the Invention

The present invention relates to a projector that magnifies and projects displayed images by means of a projection optical system so as to obtain large-screen displayed images. Especially, the present invention relates to a brightness-improved projector using a color wheel to which the filter element of a time-sharing type spectral device is applied.

2. Description of the Related Art

A projector (a projection-type image display device) used in home theaters, presentations, etc. in which to magnify and project displayed images by means of a projection optical system so as to obtain large-screen displayed images has been commercialized. This type of projector displays, while applying light sources as an illuminant, images on a screen through an electro-optical device using a spatial optical modulator such as a digital micromirror device or a liquid crystal display device. The projector may use a high-pressure mercury vapor lamp or a xenon lamp as the light sources. Due to content of mercury or problems caused by calorific values, the high-pressure mercury vapor lamp or the xenon lamp appears to be not appropriate. Accordingly, in recent years a projector applying a light emitting diode (LED) or a laser has been developed.

For example, as the projector using the LED and the laser, a projector manufactured by Casio Computer Co., Ltd. has been exhibited at the International CES (Consumer Electronics Show), the trade show of consumer electronics, held in the United States in 2010. In the projector, the LED is used for a red illuminant; a blue laser is used for a blue illuminant; and what the phase and the wavelength of a blue laser is converted is used for a green illuminant (hereinafter called this type of projector as the “hybrid type”). Further, in this type of projector, a color wheel as the time-sharing type of a filter device that rotates at a high speed has been generally applied (see, for example, Japanese Patent Application Laid-Open No. 2004-341105). Still further, in this type of projector, for effectively using light from illuminants, an integrator rod may be used (see, for example, Section [0020] and FIG. 8 recited in Japanese Patent No. 3589225).

In a color composite method regarding the above hybrid type projector, FIG. 14 shows the schematic diagram thereof. In FIG. 14, a projector 100 is composed of a blue illuminant 1, a red illuminant 2, a color wheel 5, dichroic mirrors 3, 8, lenses 4, 9, mirrors 6, 7, a digital micromirror device 10, a projection optical system 11, and a screen 12. Blue light (B) emitted from the blue illuminant 1 is irradiated on the color wheel 5 after passing through the dichroic mirror 3 and the lens 4. The color wheel 5 has a circular main body made of metal, and the specific portion of the main body is formed with a phosphor layer in a circumferential direction, the phosphor layer emitting green light (G) (hereinafter referred to as the “green phosphor”). The blue light is adapted to pass through a portion where the green phosphor layer is not provided (that is, the portion where a cutout portion is provided in a circumferential direction). The blue light then permeates the dichroic mirror 8 and is collected by means of the lens 9 so as to reach to the digital micromirror device 10.

The blue light that has been reflected from the color wheel 5 partially goes back to the side of the blue illuminant 1. When the blue light is irradiated on the green phosphor, the green light is to be emitted. This green light is then passed through the lens 4 and reflected by the dichroic mirror 3 which reflects the green light. The green light is then reflected by the mirrors 6, 7 and the dichroic mirror 8, and collected by the lens 9 so as to reach to the digital micromirror device 10.

In addition, red light (R) emitted from the red illuminant 2 passes through the dichroic mirror 3 and is reflected by the mirrors 6, 7 and the dichroic mirror 8. The red light (R) is then collected by the lens 9 and reach to the digital micromirror device 10. In three primary colors of the blue light (B), the green light (G) and the red light (R) that are introduced into the digital micromirror device 10, their incident lights are converted in synchronization so that the three primary colors are processed in time series to produce images of each own color. The images are then projected on the screen 12 through the projection optical system 11.

Here, in the hybrid type projector of the above, the blue light permeates the cutout portion of the metal-made color wheel and is introduced into the green phosphor layer formed on the color wheel so as to exit out the green light. However, since the blue light is partially reflected from the color wheel main body toward the side of the blue illuminant, it cannot be said that the blue light is effectively used.

Further, in this type of projector, brighter and finer projected images have been requested. To satisfy the request, brightness needs to be enhanced. For enhancing the brightness, some arts have taught methods to have white light from three primary colors of light obtained from blue illuminants (See Japanese Patent Application No. 2000-112031, and claims 1, 2, 7 and Section [0013], [0025], [0044] etc. of Japanese Patent Application Laid-Open No. 2004-325874). In the Japanese Patent Application No. 2000-112031, some features of obtaining the white light are disclosed in view of the structure of illuminants. On the other hand, in a projected display device disclosed in Japanese Patent Application No. 2004-325874, some features can be found in that the projected display device comprises: a spread light source made of an ultraviolet emission element; a spread phosphor that converts ultraviolet light emitted from the spread light source into a predetermined fluorescent color and exits out light with predetermined fluorescent colors; a light modulation means that modulates light emitted from the spread phosphor based on image signals given; and a projection optical means that projects light that has been modulated by the light modulation means. Here, light emitted from the spread phosphor becomes white light. This while light is produced by a color filter that can emit a plurality of color lights. Although the white light is obtainable, structures to obtain the white light need to be complicated.

### SUMMARY OF THE INVENTION

The present invention has been made in light of the above problems, and it is an object of the present invention to provide a projector that can more effectively utilize blue light than conventional projectors for easily obtaining white light.

In order to achieve the object described above, according to a first aspect of the present invention, there is provided a projector at least comprising: a light source; a color wheel; a condensing lens; a spatial light modulator; and a projection optical system, wherein the light source includes a red illuminant and a blue illuminant, and the color wheel includes a disc made of optically permeable materials, the disc being composed of a green-light generating portion, a blue-light generating portion and a blue-and-green light generating portion, the green-light generating portion and the blue-and-green light generating portion each including a phosphor layer.

The projector of the above is categorized into a type as that the blue light and the green light are adapted to permeate the color wheel. In conventional hybrid type projectors, blue light irradiated on green phosphor layers is to be reflected with a great amount due to reflection from the surface of the green phosphor layers as well as reflection from a base color wheel main body. Contrary to the conventional hybrid type projectors, in the present invention, although the blue light and the green light are reflected from the color wheel, these reflected lights are re-used so that all of the lights become permeable. Accordingly, not only can be the blue light effectively used, but also white light can be easily obtained so as to enhance the brightness of projected images.

In the first aspect of the present invention, the blue-light generating portion comprises an anti-reflection layer into which blue light is transmittable; the green-light generating portion comprises the phosphor layer that emits green light, a filter and an anti-reflection layer; and the blue-and-green light generating portion comprises the phosphor layer that emits the green light, a filter and an anti-reflection layer as that an intensity ratio of the green light relative to the blue light is 10% to 25%.

In the projector with this configuration, the blue-and-green light generating portion sets the intensity of the green light to 10 to 25% relative to the intensity of the blue light whereby not only can be the blue light effectively used, but also white light can be easily obtained, contributing to enhancement of the brightness of projected images.

In a second aspect of the present invention, there is provided a projector at least comprising: a light source; a color wheel; a condensing lens; a spatial light modulator; and a projection optical system, wherein the light source includes a red illuminant and a blue illuminant, and the color wheel includes a disc made of optically permeable materials, the disc being composed of: a green-light generating portion that includes a green phosphor layer emitting green light, a filter and an anti-reflection layer; and a blue-light generating portion that is composed of an anti-reflection layer through which blue light is passed, and wherein green light exited out from the green phosphor layer of the green-light generating portion and blue light passed through the anti-reflection layer of the blue-light generating portion are transmitted through the color wheel so as to be introduced into a spatial light modulator along with red light emitted from the red illuminant.

In the projector with this configuration, in addition to the effect of the first aspect, since the blue light and the green light are adapted not to reflect from but to pass the color wheel, it would be possible to effectively use the blue light.

In a third aspect of the present invention, there is provided a projector at least comprising: a light source; a color wheel; a condensing lens; a spatial light modulator; and a projection optical system, wherein the light source is a blue illuminant, and the color wheel includes a disc made of optically permeable materials, the disc being composed of a blue-light generating portion, a green-light generating portion, a red-light generating portion, and a green-and-red light generating portion, the green-light generating portion, the red-light generating portion, and the green-and-red generating portion each including a phosphor layer.

In the projector with this configuration, the same effect as the first aspect is obtainable since three primary colors (blue light, green light and red light) and also white light are obtainable only with the blue illuminant.

In the third aspect of the present invention, the blue-light generating portion comprises an anti-reflection layer into which blue light is transmittable; the green-light generating portion comprises the phosphor layer that emits green light, a filter and an anti-reflection layer; the red-light generating portion comprises the phosphor layer that emits the red light, a filter and an anti-reflection layer; and the green-and-red generating portion comprises the phosphor layer that emits the green light and the red light, a filter and an anti-reflection layer as that an intensity ratio of the green light and the red light relative to the blue light is each 10% to 25%.

In the projector with this configuration, the green-and-red generating portion will emit the green light and the red light in such a manner that the intensity ratios of the green light and the red light are each set to 10 to 25% relative to the blue light. Accordingly, it would be possible that not only can be the blue light effectively used, but also white light can be easily obtained whereby the same effect as the first aspect is obtainable.

In a fourth aspect of the present invention, there is provided a projector at least comprising: a light source; a color wheel; a condensing lens; a spatial light modulator; and a projection optical system, wherein the light source includes a blue illuminant, and the color wheel includes a disc made of optically permeable materials, the disc being composed of: a green-light generating portion that includes a green phosphor layer emitting green light, a filter and an anti-reflection layer; a red-light generating portion that includes a red phosphor layer emitting red light, a filter and an anti-reflection layer; and a blue-light generating portion that is composed of an anti-reflection layer through which blue light is passed, and wherein the green light exited out from the green phosphor layer of the green-light generating portion, the red light exited out from the red phosphor layer of the red-light generating portion and the blue light passed through the anti-reflection layer of the blue-light generating portion are transmitted through the color wheel so as to be introduced into a spatial light modulator,

In the projector with this configuration, since the blue light passed through the anti-reflection layer, the green light emitted from the green phosphor layer, and the red light emitted from the red phosphor layer all permeate the color wheel, those lights can be all effectively utilized. Further, since the light source is only the blue illuminant, it would be possible to reduce a number of power sources to the minimum.

In all of the aspects, an integrator rod is providable between the condensing lens and the color wheel.

In the projector with this configuration, light beams that have been reflected from the color wheel and directed to the light source are to be introduced into the integrator rod and then re-directed toward the color wheel side after the light beams have been reflected in the integrator rod. Accordingly, it would be possible to re-use blue reflected lights. Further, it would be also possible to re-use light emitted from the green phosphor.

In all of the aspects, an anti-reflection layer is formable on any of the phosphor layers.

In the projector with this configuration, since the anti-reflection layer may be formed on the phosphors, it would be possible to reduce reflection of blue lights from the phosphors, contributing to the effective use of the blue light.

In all of the aspects, the surface of the phosphor layers may be roughened.

In the projector with this configuration, since the surface of the phosphor layers may be roughened, it would be possible to reduce reflection of blue lights, contributing to the effective use of the blue lights.

### BRIEF DESCRIPTION OF THE DRAWINGS

FIG. 1A is a schematic diagram that shows a projector to which a 2 light-source type projection image display device according to one embodiment of the present invention is applied;

FIG. 1B is a schematic diagram that shows a projector to which a 2 light-source type projection image display device according to another embodiment of the present invention is applied;

FIG. 2A is a diagram that shows the specific arrangement of phosphor layers of a color wheel applied in FIG 1A;

FIG. 2B is a diagram that shows the specific arrangement of phosphor layers of a color wheel applied in FIG. 1B;

FIG. 3A is a diagram that schematically shows the sectional structure of the color wheel according to the embodiment of FIG. 2A wherein: FIG. 3A(a) shows a sectional portion where any phosphor layer is not formed on a color wheel main body so that only a blue light is allowed to be passed through, and FIG. 3A(a) also shows a diagram that conceptually indicates a relation between blue light (B) and green light (G); FIG. 3A(b) shows a sectional portion where a green phosphor layer is formed on the color wheel main body, and FIG. 3A(b) also shows a diagram that conceptually indicates a relation between the green light (G) emitted from the green phosphor layer and the blue light (B); FIG. 3A(c) shows a sectional portion where the green phosphor layer is formed on the color wheel main body, and FIG. 3A(c) also shows a diagram that conceptually indicates a relation between the green light (G) emitted from the green phosphor layer and the blue light (B); and FIG. 3A(d) shows an effect in case that a light-intensity softening phosphor layer is provided on the transparent portion of the color wheel in relation between a light intensity and a wavelength;

FIG. 3B is a diagram that schematically shows the sectional structure of the color wheel according to the embodiment of FIG. 2B wherein FIG. 3B(a) shows a sectional portion where a green phosphor layer is formed on a color wheel main body, and FIG. 3B(a) also shows a diagram that conceptually indicates a relation between green light (G) emitted from the green phosphor layer and blue light (B); and FIG. 3B(b) shows a sectional portion where any phosphor layer is not formed on the color wheel main body so that only a blue light is allowed to be passed through, FIG. 3B(b) also shows a diagram that conceptually indicates a relation between the blue light (B) and the green light (G);

FIG. 4 is a chromaticity diagram under a condition that respective luminescent ratios of blue light, green light and red light is set to I wherein A indicates a position that the whole color becomes nearly yellow;

FIG. 5 is a coordinate that shows the blue light, the green light and the red light in case of FIG. 4;

FIG. 6 is a diagram that shows the wavelength of three primary colors in case of FIG. 4;

FIG. 7 is a diagram showing that the green light and the red light are set to 10% to 25% relative to the intensity of the blue light in case of the embodiment of FIG. 1A;

FIG. 8 is a chromaticity diagram showing that white light is obtainable when three primary colors are set to the intensity ratio of FIG. 7;

FIG. 9A is a schematic diagram that shows a projector to which a single light-source type projection image display device according to the third embodiment of the present invention is applied;

FIG. 9B is a schematic diagram that shows a projector to which a single light-source type projection image display device according to the fourth embodiment of the present invention is applied;

FIG. 10A is a diagram that shows the specific arrangement of phosphor layers of a color wheel applied to the device of FIG. 9A;

FIG. 10B is a diagram that shows the specific arrangement of another phosphor layers of a color wheel applied to the device of FIG. 9B;

FIG. 11A is a diagram that schematically shows the sectional structure of a color wheel according to the embodiment of FIG. 10A wherein: FIG. 11A(a) shows a sectional portion where any phosphor is not formed on a color wheel main body so that only blue light is allowed to be passed through, and FIG. 11A(a) also shows a diagram that conceptually indicates a relation between blue light (B), green light (G) and red light (R); FIG. 11A(b) shows a sectional portion where a green phosphor layer is formed on the color wheel main body, and FIG. 11A(b) also shows a diagram that conceptually indicates a relation between the green light (G) emitted from the green phosphor layer, the blue light (B) and the red light (R); and FIG. 11A(c) shows a sectional portion where a red phosphor layer is formed on the color wheel main body, and FIG. 11A(c) also shows a diagram that conceptually indicates a relation between the red light (R) emitted from the red phosphor layer, the blue light (3) and the green light (G); and FIG, 11A(d) shows a sectional portion where a green-and-red phosphor layer is formed on the color wheel main body, and FIG. 11A(d) also shows a diagram that conceptually indicates a relation between the red light (R), the green light (G) and the blue light (B) emitted from the green-and-red phosphor layer;

FIG. 11B is a diagram that schematically shows the sectional structure of the color wheel according to the embodiment of FIG. 10B wherein: FIG. 11B(a) shows a sectional portion where a green phosphor layer is formed on a color wheel main body, and FIG. 11B(a) also shows a diagram that conceptually indicates a relation between green light (G) emitted from the green phosphor layer, blue light (B) and red light (R); FIG. 11B(b) shows a sectional portion where a red phosphor layer is formed on the color wheel main body, and FIG. 11B(b) also shows a diagram that conceptually indicates a relation between the red light (R) emitted from the red phosphor layer, the blue light (B) and the green light (G); and FIG. 11B(c) shows a sectional portion where any phosphor is not formed on, the color wheel main body so that only the blue light (B) is allowed to be passed through, and FIG. 11B(c) also shows a diagram that conceptually indicates a relation between the blue light (B), the green light (G) and the red light (R);

FIG. 12 is a diagram that shows the wavelength of three primary colors when the three primary colors are set to the intensity ratio of FIG. 7;

FIG. 13A is a diagram that shows an anti-reflection layer additionally placed on the phosphor layer of the color wheel applicable in the present invention;

FIG. 13B is a diagram that shows roughened treatments on the phosphor surface of the color wheel applicable in the present invention; and

FIG. 14 is a schematic diagram of a conventional hybrid type projector.

### DETAILED DESCRIPTION OF THE PREFERRED EMBODIMENTS

### The First Embodiment

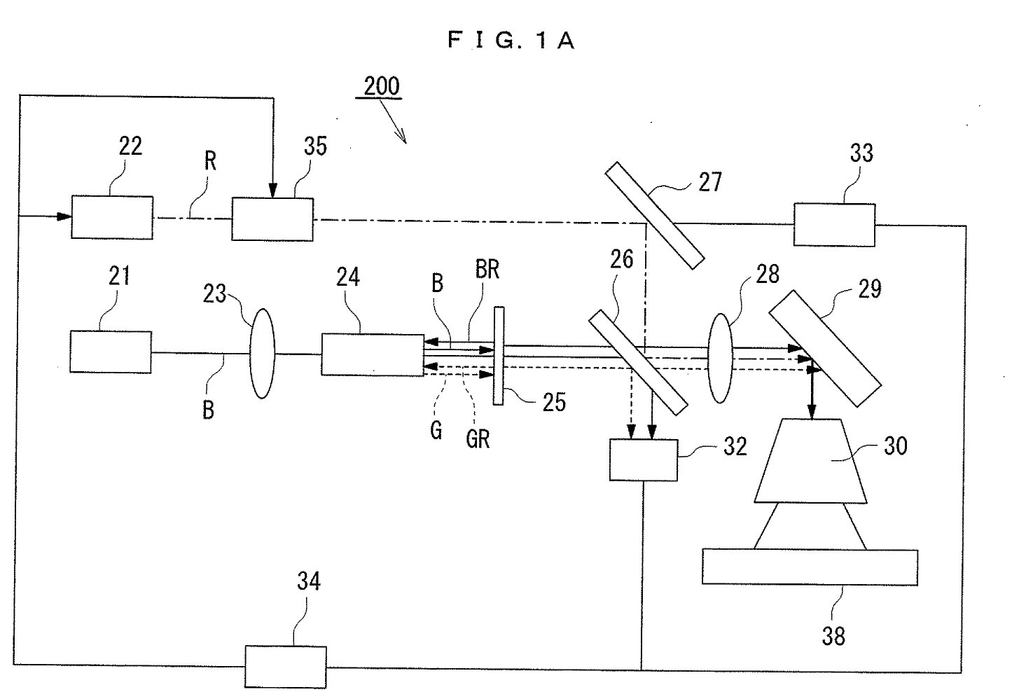

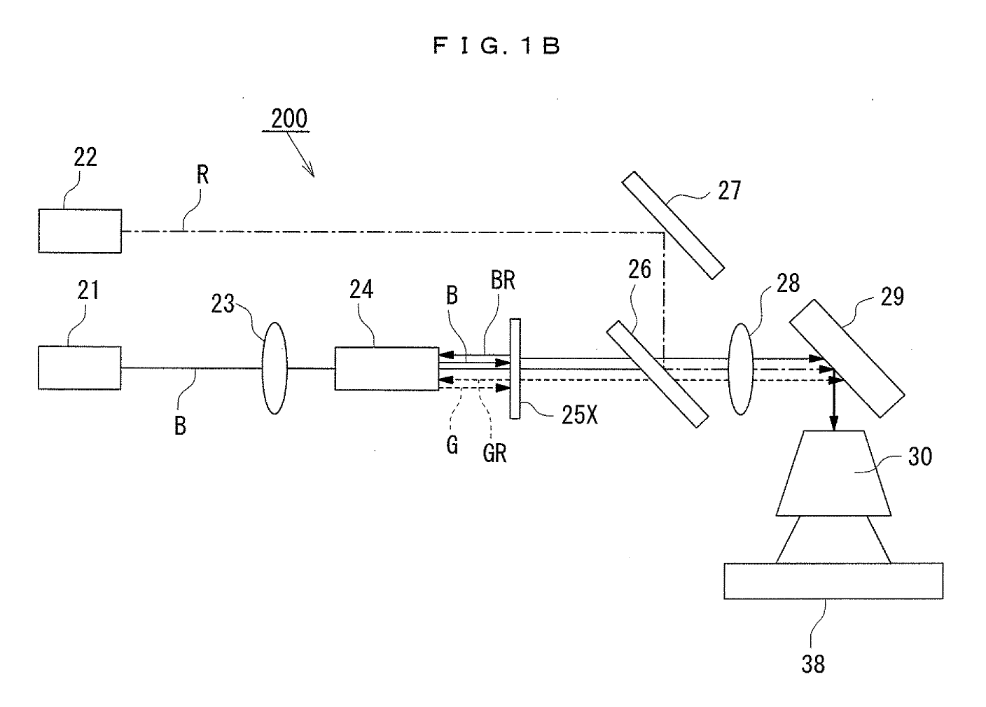

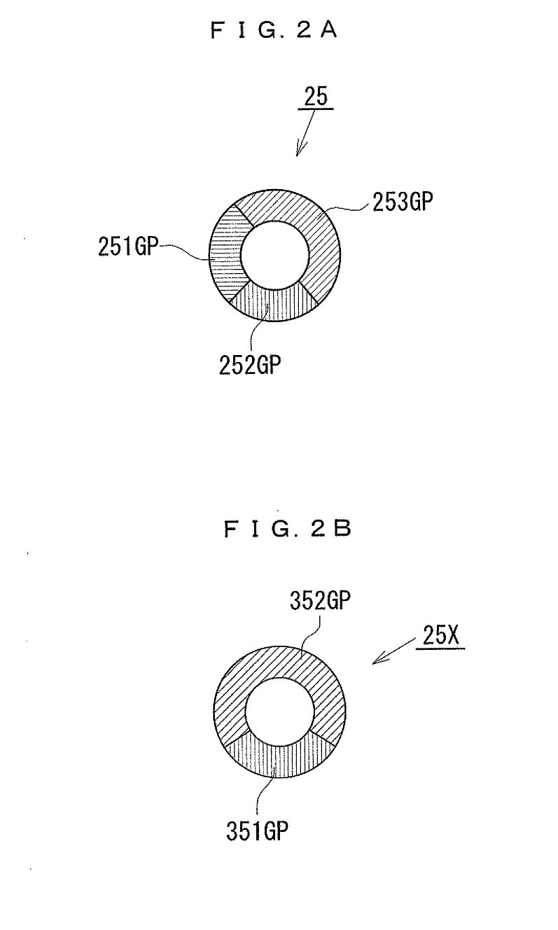

The first embodiment of the present invention will be hereinafter described with reference to the accompanying drawings. Based on FIGS. 1A and 2A, a projector according to the first embodiment of the present invention will be explained. Rotational control for a color wheel or light control after light passes through the color wheel may be any well-known art, so that the detail explanation thereof will be omitted.

According to a projector 200 as a projection image display device of a dual light-source type as shown in FIG. 1A, a blue illuminant 21 may be a laser light source, a light emitting diode, etc. Blue light emitted from the blue illuminant 21 is introduced into an integrator rod 24 after passing through a condensing lens 23. The integrator rod 24 may be a well-known device as long as light is allowed to be continuously reflected inside thereof. Light that has been passed through the integrator rod 24 will be then introduced into a color wheel 25. The color wheel 25 may be a circular plate where its main body is made of optically permeable materials (optical glasses, synthetic resins, etc.). The color wheel 25 is adapted to rotate at a high speed by means of a motor (not shown).

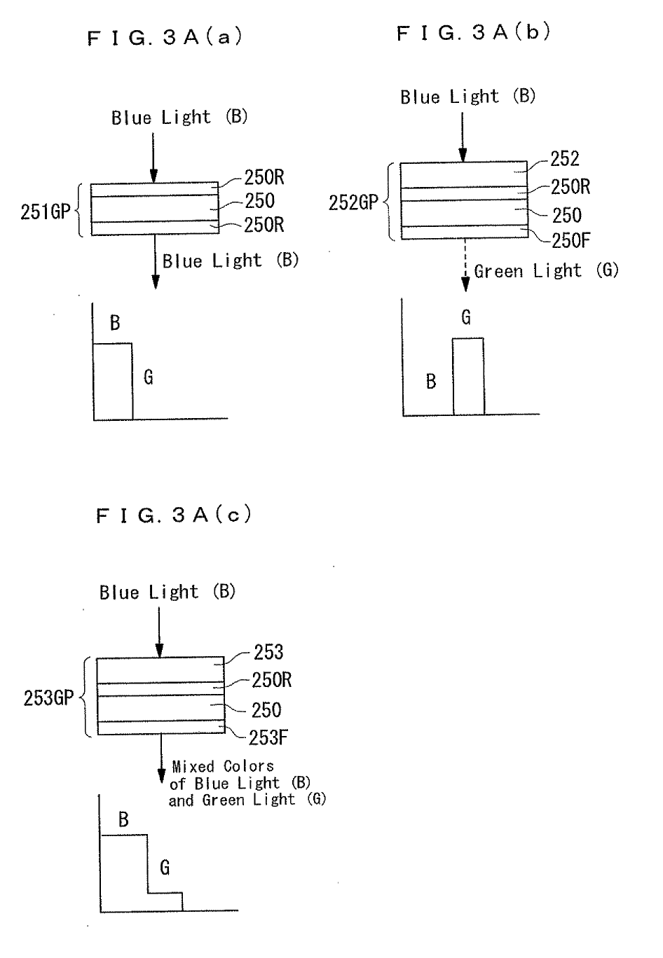

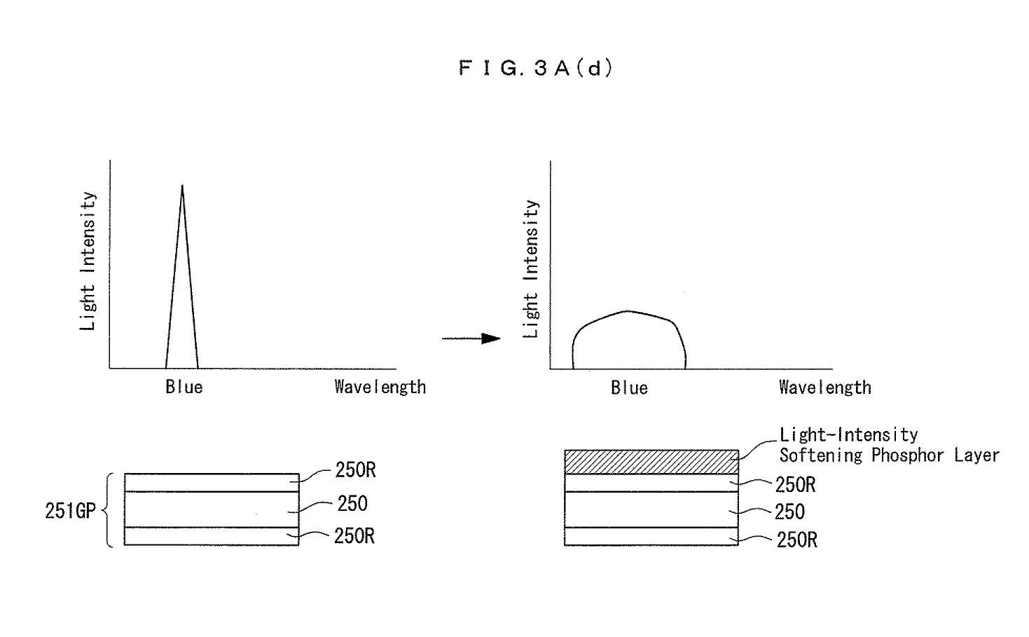

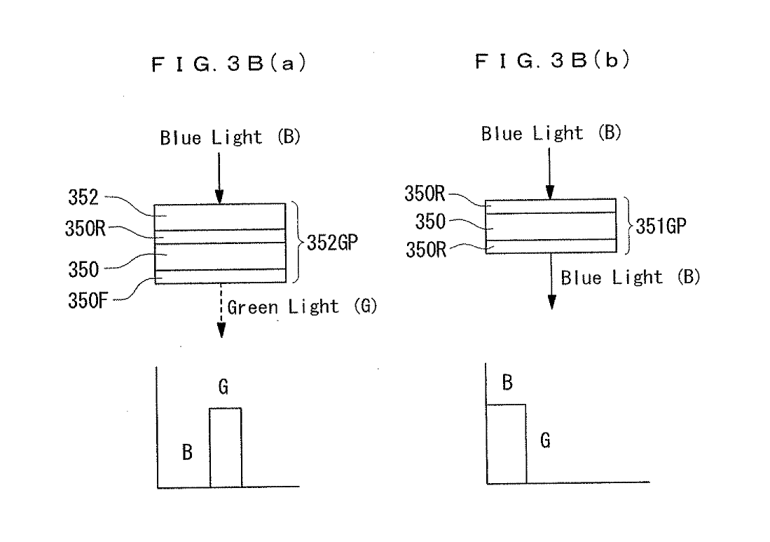

As shown in FIG. 2A, the color wheel 25 is composed of a blue-light generating portion 251GP that transmits blue light, a green-light generating portion 252GP that transmits green light, and a blue-and-green light generating portion 253GP that transmits the blue light and the green light. Detail of these generating portions will be hereinafter explained. For example, as shown in FIG. 3A(a), at the blue-light generating portion 251GP through which the blue light is passed, an anti-reflection layer 250R is formed on a color wheel main body 250. Further, as shown in FIG. 3A(b), at the green-light generating portion 252GP through which the green light is passed, a green phosphor layer 252 is formed on the color wheel main body 250 through the anti-reflection layer 250R, the green phosphor layer 252 emitting the green light when the blue light is irradiated thereon. The green light then exits out from the color wheel 25 through a filter 250F that eliminates the blue light. As also shown in FIG. 3A(c), at the blue-and-green light generating portion 253GP that transmits the blue light and the green light, as the same with the green-light generating portion 252GP, the green phosphor layer 253 is provided on the color wheel main body 250 through the anti-reflection layer 250R. Here, by adjusting the lamination thickness of a filter 253F as well as a laminated number of the filter 253F, the green light is set to approximately 15% relative to the intensity of the blue light. Light that exits out from the filter 253F will be mixed colors composed of the blue light and the green light.

The filter 250F and 253F are each structured with a dielectric multiplayer as that light with a certain wavelength that is emitted from the phosphor layers is allowed to pass through. Considering the multilayer structure, it may apply the laminated structure of titanium oxide (TiO₂) and silicon oxide (SiO₂), or tantalum pentoxide (TaO₅) and silicon oxide (SiO₂). It may modify an area at which the phosphor layer is formed according to the ratio of light passing through. Further, if necessary, a diffusion plate that diffuses light may be provided on a side where light exits out. Still further, a light-intensity softening phosphor layer in which to extend a blue zone (a blue wavelength) may be formed on the transparent portion of the color wheel 25 (such as on the blue-light generating portion 251GP) on the light incident side of the color wheel 25. See FIG. 3A(d) in the case of the blue-light generating portion 251GP. As shown, when there is no light-intensity softening phosphor layer, the intensity of blue light is very high with a very narrowed wavelength (forming a sharp triangular waveform). However, when the light-intensity softening phosphor layer is provided on the blue-light generating portion 251GP, the intensity of the blue light is reduced (forming a rounded waveform where its wavelength is more extended and its peak is made broad than the one without the light-intensity softening phosphor layer). It can be thus said that the light-intensity softening phosphor layer reduces the intensity of specific wavelength (blue in this case), so that it can make light closer to natural sunlight.

When the blue light is irradiated on the green phosphor layer 252 (see FIG. 3A(b)) along with the rotation of the color wheel 25, the green light is emitted. This green light passes through the color wheel 25 and transmits a dichroic mirror 26. The blue light that is irradiated on the blue-light generating portion 251GP of the color wheel 25 passes through the color wheel 25 and transmits the dichroic mirror 26. From the blue-and-green light generating portion 253GP, the light with mixed colors composed of the blue light and the green light will be emitted. The dichroic mirror 26 is made as that the blue light and the green light are allowed to pass through, but the red light is reflected. Among the blue lights, blue light that has been reflected from the color wheel 25 (blue light BR) is re-reflected in the integrator rod 24 and again directed toward the color wheel 25. The same can be said to the green light reflected from the color wheel 25.

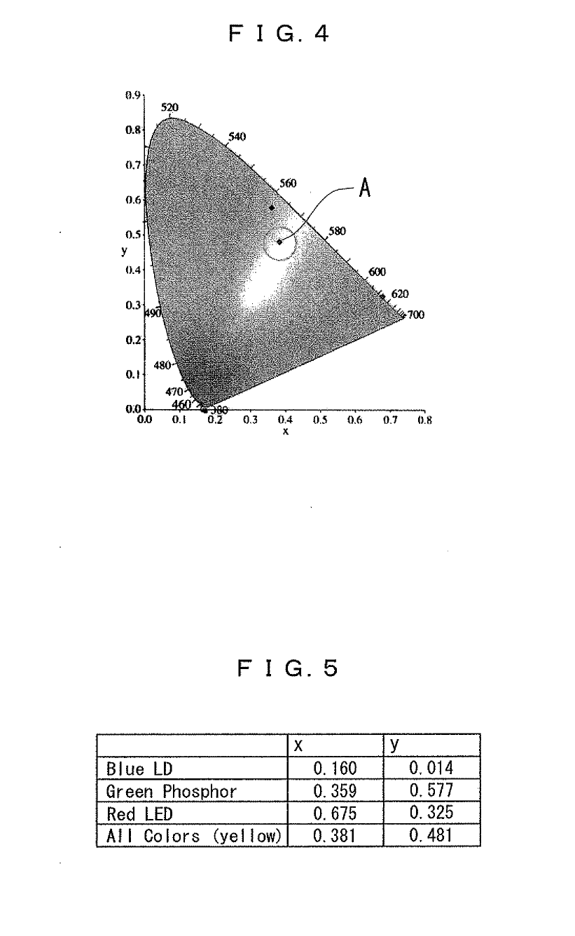

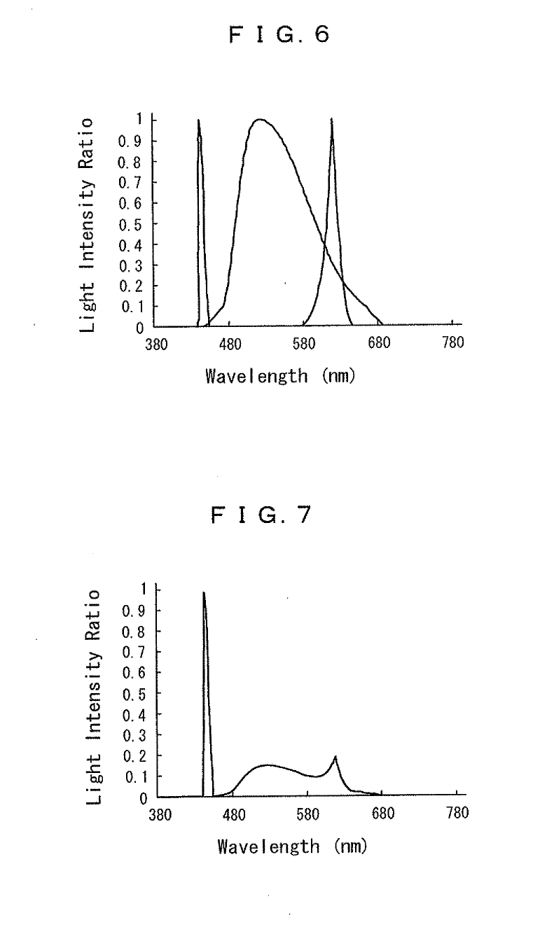

In the chromaticity diagram of FIG. 4, when a coordinate defined by the blue light (blue laser), the green phosphor, and the red light (light emitting diode) as shown in FIG. 5 is determined, when the luminous ratio of all three primary colors is 1 (see FIG. 6), its luminous color will be yellow (see A in FIG. 4). Further, the green phosphor layer 253 is provided at the blue-and-green light generating portion 253GP of the color wheel 25, as the same with FIG. 3A(b). Here, by adjusting the laminated thickness of the filter 253F and a number of the lamination of the filter 253F, the green light is set to approximately 15% relative to the intensity of the blue light. The red light emitted from a red illuminant 22 is reflected by a mirror 27 and the dichroic mirror 26. Relative to the intensity of the blue light, the red light is set to approximately 20% (see FIG. 7).

Accordingly, in FIG. 1A, a light intensity detector 33 composed of either an illumination intensity sensor or a color sensor is arranged behind the mirror 27. The intensity of the red light is thus measured, and the measured signal is then inputted into a light volume regulator 34. Further, the intensity of the blue light and the green light that has passed through the color wheel 25 and has been reflected by the dichroic mirror 26 is measured by means of a light intensity detector 32 composed of either an illumination intensity sensor or a color sensor. As the same, the measured signal is then inputted into the light volume regulator 34.

Based on the signal from the light volume regulator 34, the red illuminant 22 is performed. Here, it would be possible that the signal from the light volume regulator 34 is not sent back to the red illuminant but returned to an iris 35 (the iris 35 is replaceable by a variable ND filter) so as to adjust the intensity of the red light. As regards the wavelength of the three primary colors in a relative relation, see FIG. 6.

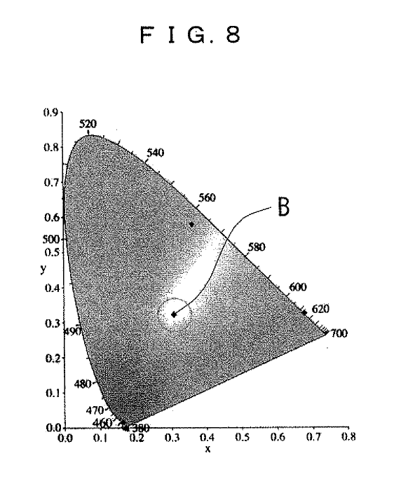

As discussed hereinabove, while decreasing the intensity of the green light and the red light relative to the blue light, white light is obtained. See “B” in the chromaticity diagram of FIG. 8. Thus, light that has passed through the blue-and-green light generating portion 253GP of the color wheel 25 transmits the dichroic mirror 26. The light then becomes white light after mixing with the red light.

The blue light, the green light, and the red light that are emitted from the color wheel 25 as well as the white light are introduced into a digital micromirror device 29 and then processed in time series. Images are then projected on a screen 38 through a projection optical system 30.

According to the first embodiment of the present invention, compared to conventional devices, the green light produced by which the blue light is irradiated on the green phosphor layer passes through the color wheel so as to be able to reduce the reflection of the blue light, contributing to effective usage of the blue light. When the green light is set to approximately 15%, and the red light is set to approximately 20% relative to the intensity of the blue light, it would be possible to increase the brightness of the white light.

### The Second Embodiment

Next, compared to the projector 200 of the first embodiment, the second embodiment of the present invention will be hereinbelow explained with reference to FIG. 1B. The device of FIG. 1B does not include the light intensity detectors 32, 33, the light volume regulator 34, and the iris 35. The basic structure of a device shown in FIG. 1B is the same with the one of FIG. 1A. In a color wheel 25x, as shown in FIG. 2B, a green-light generating portion 352GP is formed, extended up to 240 degrees in the circumferential direction of a disc. The rest of the disc is formed with a blue-light generating portion 351GP. A green phosphor layer 352 may be formed at the most top layer of the green-light generating portion 352GP as shown in FIG. 3B(a). On the other hand, the blue-light generating portion 351GP includes an anti-reflection layer 350R (see FIG. 3B(b)). A region where the green phosphor layer 352 is formed is modifiable according to the ratio of transmitted light. In the color wheel 25x, between the green phosphor layer 352 and a color wheel main body 350, an anti-reflection layer 350R is provided. Further, on the most bottom side of the green-light generating portion 352GP of the color wheel 25x, a filter 350F that eliminates the blue light is provided. Further, if necessary, a diffusion plate that diffuses light may be provided on the bottom side of the green-light generating portion 352GP. Or, a light-intensity softening phosphor layer extending a blue zone may be formed on the blue-light generating portion 351GP of the color wheel 25x. See the explanation that has been discussed hereinabove in case of the blue-light generating portion 25IGP with reference to FIG. 3A(d).

When the blue light is irradiated on the green phosphor layer 352 of the green-light generating portion 352GP along with the rotation of the color wheel 25x, the green light is emitted (see FIG. 3B(a)). This green light is adapted to pass through the color wheel 25x and transmit the dichroic mirror 26. The blue light that has been irradiated on the blue-light generating portion 351GP passes through the color wheel 25x and transmits the dichroic mirror 26. The dichroic mirror 26 is fabricated as that blue lights and green lights are passed through, but red lights are reflected. Among the blue lights, blue light BR that has been reflected from the color wheel 25x is re-reflected in the integrator rod 24 and again directed toward the color wheel 25x. The same can be applicable to green light GR reflected from the color wheel 25x.

The red light emitted from the red illuminant 22 is reflected from the mirror 27 and the dichroic mirror 26. The blue light and the green light that transmit the dichroic mirror 26, and the red light that is reflected from the dichroic mirror 26 pass through the lens 28 and then introduced into the digital micromirror device 29. The introduced light is processed in time series so that images are projected on the screen 38 through the projection optical system 30.

According to the second embodiment of the present invention, compared to conventional devices, the green light produced by which the blue light is irradiated on the green phosphor layer 352 transmits the color wheel 25x thereby reducing the reflection of the blue light, thus contributing to the effective usage of the blue light.

### The Third Embodiment

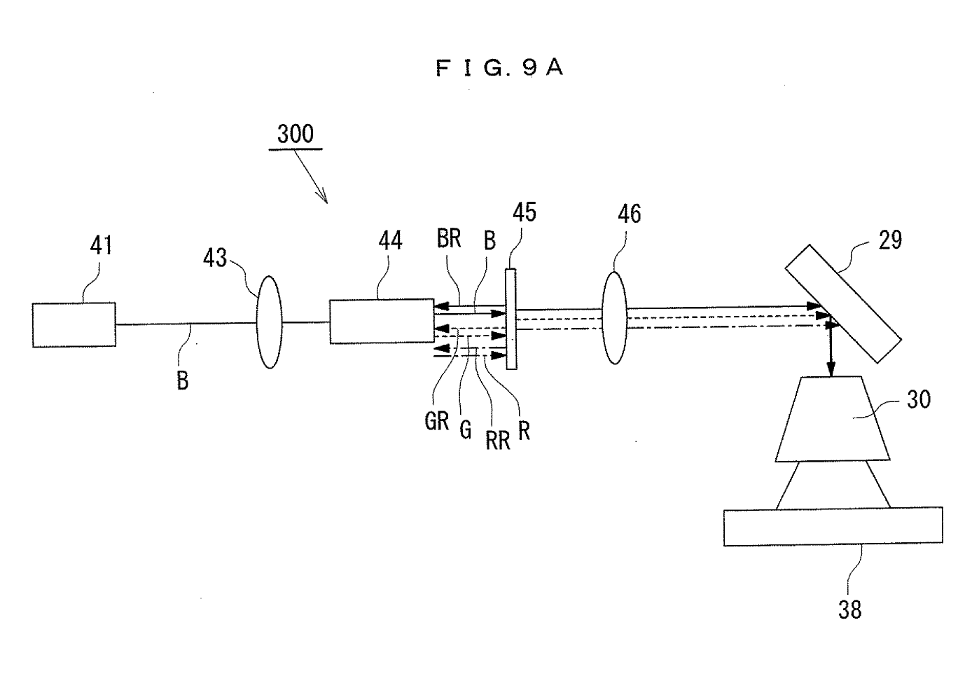

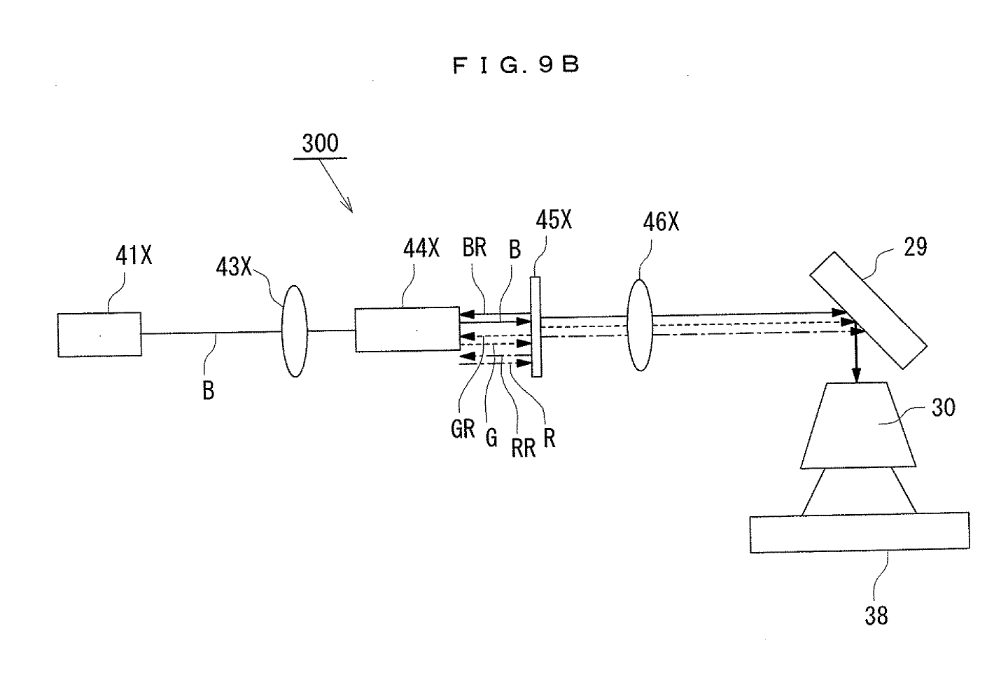

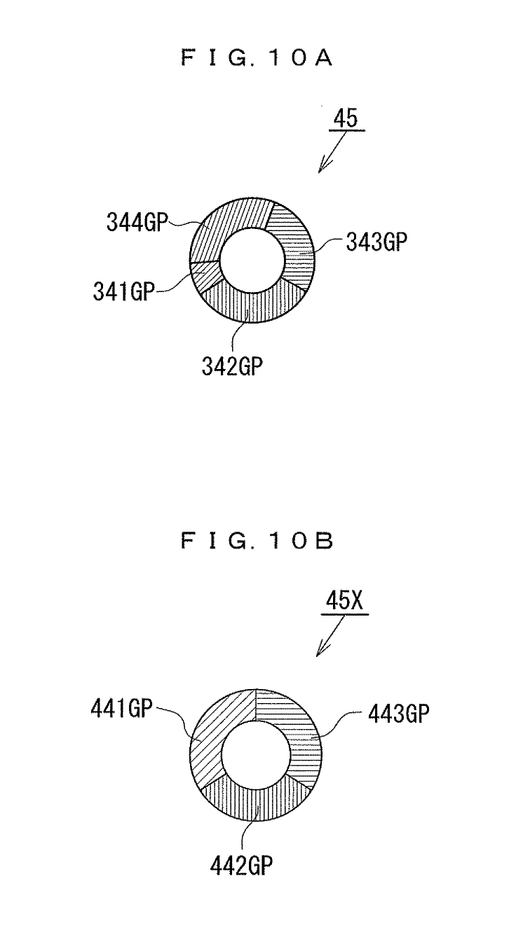

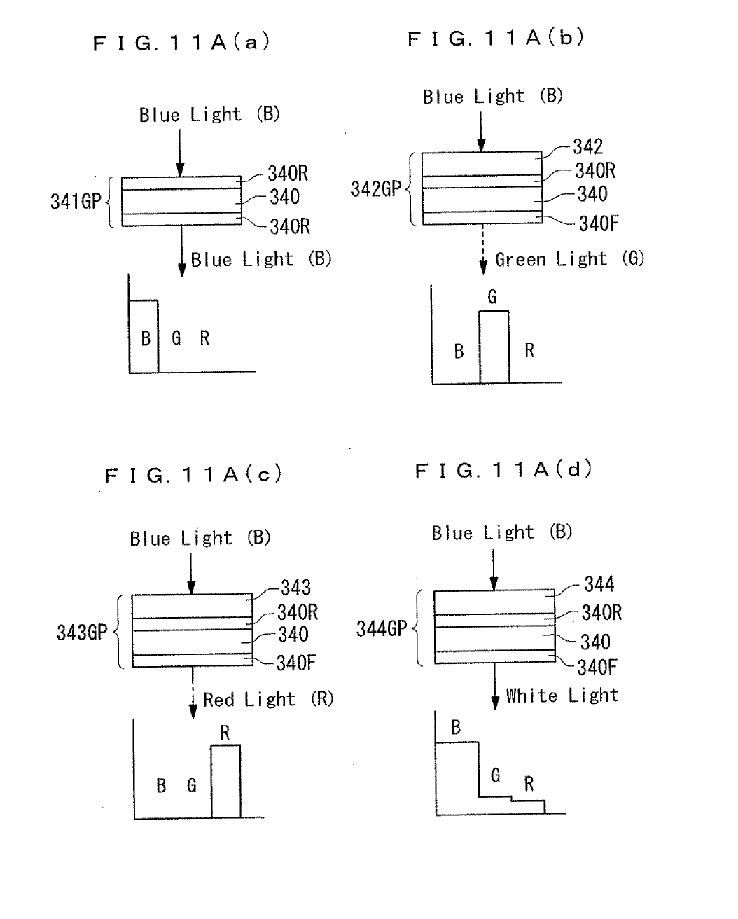

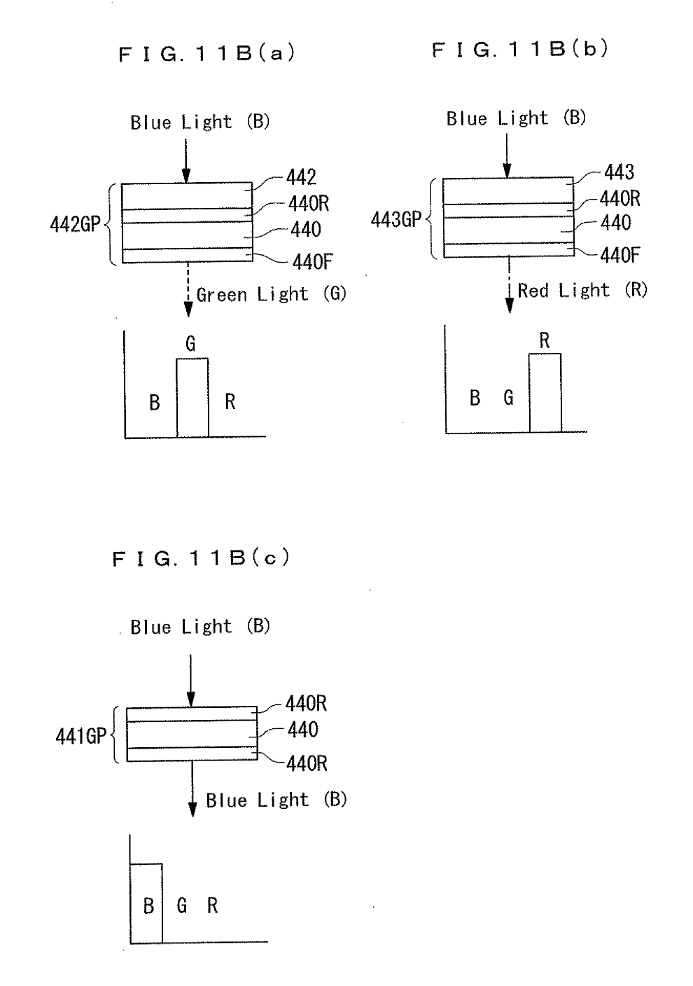

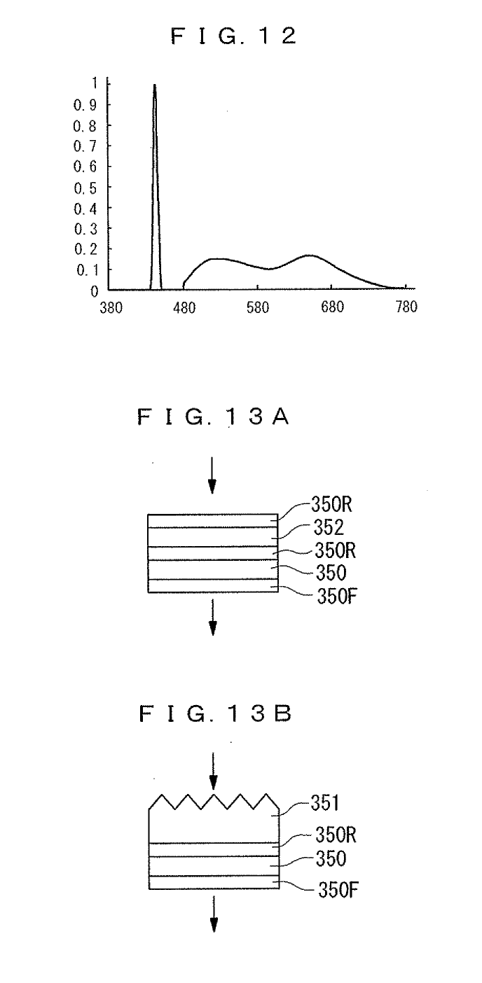

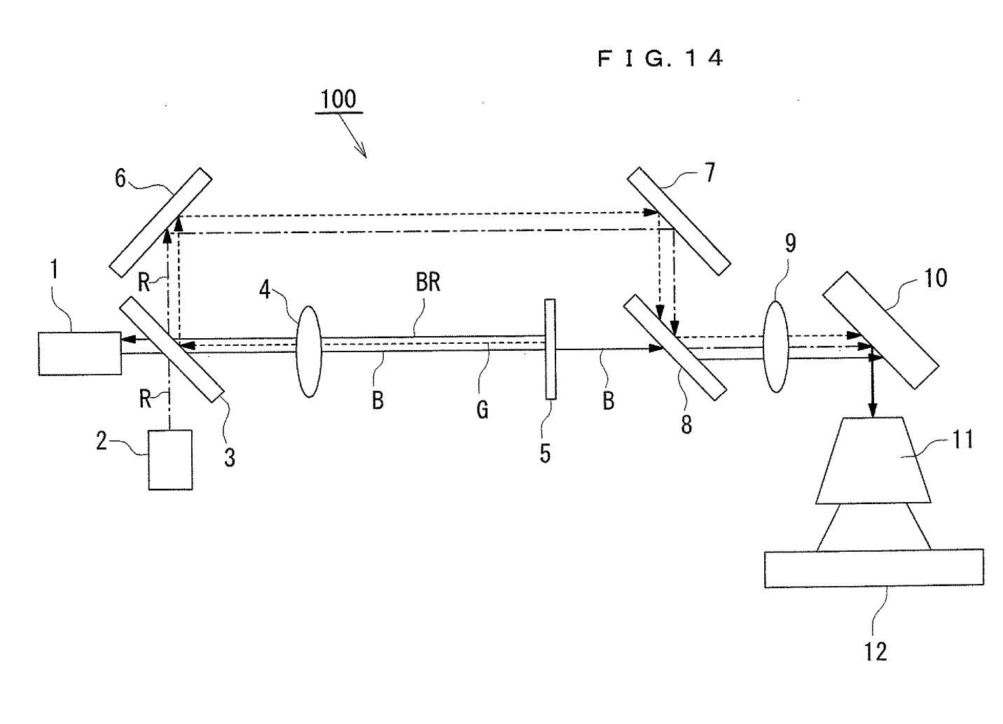

Next, the third embodiment of a projection image display device of a single light-source type according to the present invention will be hereinbelow explained. In a projector 300 as shown in FIG. 9A, blue light emitted from a blue illuminant 41 passes through a lens 43 and then introduced into a color wheel 45 through an integrator rod 44. The color wheel 45 includes a color wheel main body 340 made of an optically permeable disc (see FIG. 11A) and, as shown in FIG. 10A, is divided into 4 sections in a circumferential direction. The 4 divided sections are composed of a green-light generating portion 342GP, a red-light generating portion 343GP, a blue-light generating portion 341GP that passes blue light, and a green-and-red light generating portion 344GP composed of mixed green and red phosphor layers.

As shown in FIGS. 11A(b) and 11A(c), between a green phosphor layer 342 and the color wheel main body 340, and also between a red phosphor layer 343 and the color wheel main body 340, an anti-reflection layer (AR coat) 340R is each formed. Further, at the most bottom of the green-light generating portion 342GP and the red-light generating portion 343GP, a filter 340F is each formed. As regards the blue-light generating portion 3410P, the anti-reflection layer 340R is each formed on both sides of the color wheel main body 340. As regards the green-and-red light generating portion 344GP, a green and red phosphor layer 344 is formed on the most top thereof. See FIG. 11A(d). The layer thickness of the filter 340F and a number of the layers of the filter 340F are determined so that the intensity of the green light and the red light each becomes 10% to 25% relative to the intensity 1 of the blue light.

When the blue light is introduced into the color wheel 45, green lights, red lights, blue lights and white lights respectively exit out from the green-light generating portion 342GP, the red-light generating portion 343GP, the blue-light generating portion 341GP and the green-and-red light generating portion 344GP. To obtain white lights, the same method with the first embodiment is applicable. The blue lights, the green lights, the red lights and the white lights that have been emitted form the color wheel 45 pass through the lens and then introduced into the digital micromirror device 29 so as to be processed in time series. Images are then projected on the screen 38 through the projection optical system 30.

In the third embodiment of the present invention, compared to conventional devices, since the light source is only the blue light source, it would be possible to effectively utilize light. In addition, since the third embodiment can eliminate optical devices such as mirrors, or dichroic mirrors, it can simplify the structure of the device. Further, since the brightness of the white lights can be increased relative to three primary colors, the brightness of projected images can be expanded contributing to acquisition of clear images.

### The Fourth Images

Next, another embodiment of the single light source type will be hereinbelow explained. The structure of the whole device in FIG. 9B is the same with the third embodiment (FIG. 9A). In a color wheel 45x as shown in FIG. 1013 and FIG. 11B, a color wheel main body 440 is made of an optically permeable disc. The color wheel main body 440 is divided into 3 sections each extended by 120 degrees in a circumferential direction. The divided sections are composed of: a blue-light generating portion 441GP that transmits blue lights, a green-light generating portion 442GP and a red-light generating portion 443GP. As shown in FIGS. 11B(a) and 11B(b), between a green phosphor layer 442 and the color wheel main body 440, and also between a red phosphor layer 443 and the color wheel main body 440, an anti-reflection layer (AR coat) 440R is each formed. Further, on the most bottom of the green-light generating portion 442GP and the red-light generating portion 443GP, a filter 440F is each formed. As regards the blue-light generating portion 441GP, the anti-reflection layer 440R is each formed on both sides of the color wheel main body 440. When the blue light is introduced into the color wheel 45x, the green light, the red light, and the blue light respectively exit out from the green-light generating portion 442GP, the red-light generating portion 443GP, and the blue-light generating portion 441 GP. The blue lights, the green lights, and the red lights emitted form the color wheel 45x are passed through the lens 46x and then introduced into the digital micromirror device 29 so as to be processed in time series. Images are then projected on the screen 38 through the projection optical system 30.

In the fourth embodiment of the present invention, compared to conventional devices, since the light source is only the blue illuminant, it would be possible to effectively utilize light. In addition, since the fourth embodiment can eliminate optical devices such as mirrors, or dichroic mirrors, it can simplify the structure of a device.

The basic structure of the color wheel of the present invention is as discussed hereinabove. Here, if necessary, it would be possible to provide an integrator rod between a condensing lens and a color wheel (see, for example, FIGS. 1A and 1B). In addition, an anti-reflection layer may be further formed on any of phosphor layers (see FIG. 13A that is discussed in case of FIG. 3B(a)). Still further, on the surface of the phosphor layers (on the side into which blue light is introduced), it would be possible to conduct roughened treatments. Specifically, as shown in FIG. 13B, the surface of a phosphor 351 placed over an anti-reflection layer 350R (the surface indicated with arrow) may be subjected to the roughened treatments. Here, a layer indicated with 350F is a filter layer. With this structure also, it would be possible to prevent light from reflection, more specifically, the reflection occurred on an interface between the phosphor layer and an air layer can be inhibited. These roughened treatment conducted on the surface of the phosphor may be completed with well-known dies or nanoimprint.

Phosphor materials that have been hereinabove described may be as follows. As a phosphor for a red emission, Y₂O₃: Eu, Y₂SiO₅: Eu, Y₃Al₅O₁₂: Eu, Zn₃ (PO₄)₂: Mn, YBO₃: Eu, (Y, Gd) BO₃3: Eu, GdBO₃: Eu, ScBO₃: Eu, LuBO₃: Eu, etc. are applicable. As a phosphor for a green emission, Zn₂SiO₄: Mn, BaAl₁₂O₁₉: Mn, BaMgAl₁₄O₂₃: Mn, SrAl₁₂O₁₉: Mn, ZnAl₁₂O₁₉: Mn, CaAl₁₂O₁₉: Mn, YBO₃: Tb, LuBO₃: Tb, GdBO₃: Tb, ScBO₃: Tb, Sr₄Si₃O₈Cl₄: Eu, etc. are applicable. Lastly, as a phosphor for a blue emission, CaWO₄: Pb, Y₂SiO₅: Ce, BaMgAl₁₄O₂₃: Eu, etc. are applicable.

1. A projector at least comprising:
a light source;
a color wheel;
a condensing lens;
a spatial light modulator; and
a projection optical system,
wherein the light source includes a red illuminant and a blue illuminant, and
the color wheel includes a disc made of optically permeable materials, the disc being composed of a green-light generating portion, a blue-light generating portion and a blue-and-green light generating portion, the green-light generating portion and the blue-and-green light generating portion each including a phosphor layer.

2. The projector according to claim 1, wherein the blue-light generating portion comprises an anti-reflection layer into which blue light is transmittable; the green-light generating portion comprises the phosphor layer that emits green light, a filter and an anti-reflection layer; and the blue-and-green light generating portion comprises the phosphor layer that emits the green light, a filter and an anti-reflection layer as that an intensity ratio of the green light relative to the blue light is 10% to 25%.

3. A projector at least comprising:
a light source;
a color wheel;
a condensing lens;
a spatial light modulator; and
a projection optical system,
wherein the light source includes a red illuminant and a blue illuminant, and
the color wheel includes a disc made of optically permeable materials, the disc being composed of: a green-light generating portion that includes a green phosphor layer emitting green light, a filter and an anti-reflection layer; and a blue-light generating portion that is composed of an anti-reflection layer through which blue light is passed, and
wherein green light exited out from the green phosphor layer of the green-light generating portion and blue light passed through the anti-reflection layer of the blue-light generating portion are transmitted through the color wheel so as to be introduced into a spatial light modulator along with red light emitted from the red illuminant.

4. A projector at least comprising:
a light source;
a color wheel;
a condensing lens;
a spatial light modulator; and
a projection optical system,
wherein the light source is a blue illuminant, and the color wheel includes a disc made of optically permeable materials, the disc being composed of a blue-light generating portion, a green-light generating portion, a red-light generating portion, and a green-and-red light generating portion, the green-light generating portion, the red-light generating portion, and the green-and-red light generating portion each including a phosphor layer.

5. The projector according to claim 4, wherein the blue-light generating portion comprises an anti-reflection layer into which blue light is transmittable; the green-light generating portion comprises the phosphor layer that emits green light, a filter and an anti-reflection layer; the red-light generating portion comprises the phosphor layer that emits the red light, a filter and an anti-reflection layer; and the green-and-red light generating portion comprises the phosphor layer that emits the green light and the red light, a filter and an anti-reflection layer as that an intensity ratio of the green light and the red light relative to the blue light is each 10% to 25%.

6. A projector at least comprising:
a light source;
a color wheel;
a condensing lens;
a spatial light modulator; and
a projection optical system,
wherein the light source includes a blue illuminant, and
the color wheel includes a disc made of optically permeable materials, the disc being composed of: a green-light generating portion that includes a green phosphor layer emitting green light, a filter and an anti-reflection layer; a red-light generating portion that includes a red phosphor layer emitting red light, a filter and an anti-reflection layer; and a blue-light generating portion that is composed of an anti-reflection layer through which blue light is passed, and
wherein the green light exited out from the green phosphor layer of the green-light generating portion, the red light exited out from the red phosphor layer of the red-light generating portion and the blue light passed through the anti-reflection layer of the blue-light generating portion are transmitted through the color wheel so as to be introduced into a spatial light modulator.

7. The projector according to claim 1, further comprising an integrator rod provided between the condensing lens and the color wheel.

8. The projector according to claim 1, further comprising the anti-reflection layer formed on the phosphor layer.

9. The projector according to claim 1, wherein a surface of the phosphor layer is roughened.
